(19) United States
(12) Patent Application Publication
(10) Pub. No.: US 2018/0112436 A1
(43) Pub. Date: Apr. 26, 2018

(54) HI-SECURITY

(71) Applicant: Samir Vithal BODHE, Chiba (JP)

(72) Inventor: Samir Vithal BODHE, Chiba (JP)

(21) Appl. No.: 15/567,325

(22) PCT Filed: Apr. 26, 2015
(86) PCT No.: PCT/IB2015/053028

§ 371 Date: Oct. 17, 2017

(51) Int. Cl. E05B 45/10; E05B 35/00; E05B 51/00; E05B 9/00; G08B 13/16

(52) U.S. Cl. CPC E05B 45/10; E05B 35/001; G06Q 30/016; E05B 9/002; G08B 13/16; E05B 51/00

(57) ABSTRACT

This invention permits (or rejects) access to a secure location by authenticating precision up to 106 i.e. 10 to the power 6 or 1,000,000. Such precision allows highly secure and controlled access thereby paving a new field of finer control and security than the conventional security techniques based on software or hardware. Objective of this invention is to provide an additional high-robust-security wall over existing locks/vaults/security systems. Such new high-robust-security wall will allow existing owners, companies to have a hacker-proof and secure mechanism without upgrading or replacing their existing security systems in place. Another benefit of this objective is to launch new industrial sectors as below: 1. Sector (R&D Firms): Manufacture, Test and Create new alloys based on resonance frequencies needed to identify a unique key. 2. Sector (Manufactures): Mass produce such keys and metal plates for each metal once such frequencies are identified. 3. Sector (Maintenance & Support): Highly specialized Maintenance and Support services for customers utilizing this security mechanism. For example, Support services such as, customer might need help for delivering such keys securely, replace existing keys in event of malfunction of the old key, Support key and metal plate manufacturers by regularly providing updates on new alloys designed by R&D firms. 4. Sector (Private networks): Private networks connecting R&D firms and Manufacturers, and another private network connecting Manufacturers and Maintenance & Support, and another network connecting Maintenance & Support services and existing customers.

### DESCRIPTION OF THE DRAWINGS

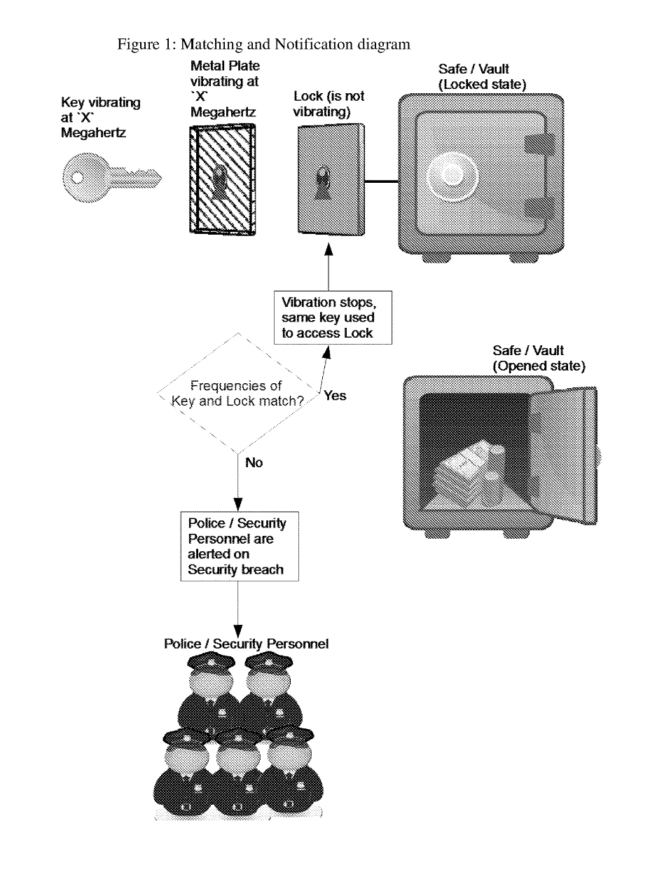

In FIG. 1, a key is shown that needs to be vibrated at ‘X’ MHz frequency. Each key will have a different frequency assigned to it, depending on its metal composition. Such frequency will be known to key manufacturer, lock manufacturer and buyer of the key. As this mechanism allows authentication of frequencies in Mega Hertz range and more finest degrees, it is possible for key and lock manufacturers to assign a large range of frequencies, each frequency being unique to a key in the entire world. As the natural resonance frequencies may vary for each metals in the periodic table, the range of such frequencies may also vary accordingly. Furthermore, alloys of 2 or more metals can be manufactured, their new resonance frequencies measured and these new range of resonance frequencies can be used for same security mechanism. By creating alloys, it is possible to expand range of resonance frequencies available beyond the resonance frequencies of metals within periodic table.

The key and metal plate both need to vibrate at exactly same frequency. Once key is inserted in metal plate, and once the frequencies of key and metal plate match, then an OK signal is given out allowing the same key to access the lock.

Should there be a mismatch of frequencies of key and metal plate, then an alarm will be given out to the Security Personnel or Remote Security system, alerting them of security breach. Once such alert has been issued, then the individual cannot access the lock, thereby preventing any further potential to breach security.

### DETAILED DESCRIPTION

Matching the resonance frequencies of vibrations of 2 objects/parameters. E.g. If a ‘lock’ is to be opened by its own ‘key’, the lock can be kept ‘vibrating’ at very high frequency with a small displacement. So, if you want to insert its ‘key’ & open the lock, you got to vibrate the ‘key’ with exactly the same frequency as that of the lock while inserting it in the lock. If the frequencies of both key and lock are exactly the same equal, then:

Relative frequency between the lock and key will be Zero, as both are vibrating in phase and at same frequency.

If the frequency of the key does not match to even a slight order, the lock will not open as the frequency of lock is not equal to the frequency of key so, the key would not fit in properly.

Thus, it can be used for security in banks where a ‘vibrating’ plate can be placed before the lock. In such case, the lock would not be required to vibrate.

If the frequency of plate and frequency of key match, a signal can be given to stop the plate from vibrating and thus the lock is ready to ‘accept’ the key.

If the frequencies mismatch to the slightest order, an alarm can be given to signify ‘unauthorized access’. The vibrations may be along X, Y or Z axis.

This effect of matching the frequency may be used in other electrical, electronic or Computer systems (where highly confidential data/objects lie protected).

The effect of ‘Magneto-Striction’ in case of metals can be thought of, as we observe displacement in 3-dimensions in the body of the metal.

The invention claims:

1. A vibrating lock and key means for securely controlling access to a property, the vibrating lock and key means comprising:
a lock apparatus and a key device, wherein a blade portion of the key device actuates a locking mechanism of the lock apparatus,
wherein the key device is composed of a vibrationally distinctive material, where said vibrationally distinctive material is characterized by having a distinct vibrational resonance profile, where said vibrational resonance profile describes one or more of a resonance frequency of the vibrationally distinctive material; and,
wherein the lock apparatus comprises one or more parts constituting a vibrating portion of the lock apparatus, where said vibrating portion of the lock apparatus is composed of the vibrationally distinctive material; and,
a vibration induction means for causing the vibrating portion of the lock apparatus to vibrate at the resonance frequency of the vibrationally distinctive material; and,
a resonance verification means for preventing the blade portion of the key device from actuating the locking mechanism of the lock apparatus unless the key device is vibrating at the same resonance frequency as is the vibrating portion of the lock apparatus, which same resonance frequency is therefore a shared resonance frequency.

2. The vibrating lock and key means of claim 1, where the vibrationally distinctive material comprises one or more metals.

3. The vibrating lock and key means of claim 1, further comprising a phase reconciliation means for causing the key device to vibrate in phase with the vibrating portion of the lock apparatus.

4. The vibrating lock and key means of claim 1, further comprising an alarm apparatus comprising means for detecting a failure of either the key device or the vibrating portion of the lock apparatus to vibrate at an expected resonance frequency; and further comprising means for issuing a response to said failure.

5. The vibrating lock and key means of claim 4, where the alarm apparatus further comprises a means for generating one more of an alarm signal and transmitting said alarm signal to one or more receiving entities.

6. The vibrating lock and key means of claim 1, where the vibrating portion of the lock apparatus comprises a face plate.

7. The vibrating lock and key means of claim 1, further comprising a magnetostriction responsive means for adjusting functional parameters of the lock apparatus to account for magnetostriction effects arising in either or both of the key device and the lock apparatus.

8. A method for making a security system comprising a lock and key apparatus that vibrates at a target resonance frequency to regulate the actuation of a lock, the method comprising the steps of:
identifying one or more candidate resonating compositions amenable for forming any part of the lock and key apparatus, where each of said candidate resonating compositions is characterized by having at least one inherent resonance frequency; and,
choosing a selected resonating composition from said one or more candidate resonating compositions for the construction of the lock and key apparatus, where a criterion for said choosing comprises the possession by the selected resonating composition of a desirable resonance frequency profile; and,
forming a body portion of a key of the lock and key apparatus from the selected resonating composition and forming a vibrating portion of a lock of the lock and key apparatus from the selected resonating composition, wherein a blade portion of the key is fashioned to actuate the lock; and,
installing the lock in a location whereby the lock is a part of a means for controlling access to a secured property, where said installing further comprises the step of joining to the lock and key apparatus a means for interfacing with a vibration induction means; and,
linking the lock and key apparatus to a clearance mechanism comprising means for detecting an authorizing vibrational match, where said authorizing vibrational match comprises a match between a frequency of vibration in the lock and key apparatus and at least one authorizing vibrational frequency;
thereby making a security system comprising a lock and key apparatus that vibrates at a target resonance frequency to regulate the actuation of a lock, so that the lock does not open unless the clearance mechanism detects the authorizing vibrational match.

9. The method of claim 8, where the authorizing vibrational frequency is the target resonance frequency.

10. The method of claim 8, wherein the vibration induction means causes either or both of the vibrating portion of the lock and the body portion of the key to vibrate at any one or more of: the target resonance frequency, and one or more of the authorizing vibrational frequency, and one or more of an alternative vibrational frequency.

11. The method of claim 8, where the authorizing vibrational match comprises a match between a frequency of vibration of the body portion of the key and a frequency of vibration of the vibrating portion of the lock.

12. The method of claim 8, where the authorizing vibrational match comprises a match between any one or more of: a frequency of vibration of the body portion of the key, and a frequency of vibration of the vibrating portion of the lock, and the target resonance frequency, and one or more of the authorizing vibrational frequency.

13. The method of claim 8, where the resonating composition is a metal-containing composition.

14. The method of claim 8, further comprising the step of linking the clearance mechanism to an alarm mechanism comprising means for detecting a mismatch in the frequency of vibration of any part of the lock and key apparatus compared to any one or more of: the target resonance frequency and the authorizing vibrational frequency; and further comprising means for reporting an alarm when the mismatch is detected.

15. The method of claim 8, wherein the vibrating portion of the lock comprises a face plate.

16. The method of claim 8, wherein the clearance mechanism further comprises means for stopping vibration of the vibrating portion of the lock after detecting the authorizing vibrational match.

17. The method of claim 8, wherein the clearance mechanism further comprises means for regulating the actuation of the locking mechanism of the lock, whereby the lock cannot be opened unless the authorizing vibrational match is detected.

18. The method of claim 8, further comprising a magnetostriction responsive means for adjusting functional parameters of the lock to account for magnetostriction effects arising in any part of the lock and key apparatus.

19. The method of claim 8, further comprising a business method, the business method comprising the steps of:
installing the security system comprising the lock and key apparatus in a particular property belonging to a customer; and,
providing support services to the customer whereby a key of the lock and key apparatus is securely prepared and securely delivered to the customer; and,
providing maintenance services to the customer whereby a maintenance need of the customer is fulfilled, where the maintenance need comprises any of: a replacing of any part of the system, and
a repairing of any part of the system, and a diagnostic evaluation of any part of the system; and,
providing security liaison services to the customer whereby one or more functions of the system is operationally linked to the performance of one or more duties performed by security agents; and,
operating a private communications network comprising means for enabling secure exchanges of communications data among a plurality of identified parties;
thereby enabling the operation of a security services business utilizing the method for making a security system comprising a lock and key apparatus that vibrates at a target resonance frequency to regulate the actuation of a lock.
LIST OF ELEMENTS
From claim 1:
A Vibrating Lock and Key Means (the whole apparatus of the invention).
A Property (any area, compartment, or items to which access is controlled by the invention).
A Lock apparatus and a Key device
The Blade Portion of the Key Device.
An example of a Locking Mechanism of one type of the Lock Apparatus.
A Vibrationally Distinctive Material
A Vibrational Resonance Profile
A Vibrating Portion of the Lock Apparatus
A Vibration Induction Means
A Resonance Verification Means
From claims 2-7:
A Phase Reconciliation Means
An Alarm Apparatus
A Magnetostriction Responsive Means
From claims 8-18:
A Security System Comprising a Lock And Key Apparatus
A Target Resonance Frequency
A Candidate/Selected Resonating composition
Metal-Containing Compositions
Selected Metal-Containing Composition
An Inherent Resonance Frequency
A Lock and Key Apparatus
A Body Portion of the Key
“A location whereby the lock is a part of a means for controlling access to a secured property”
Means for Interfacing with a Vibration Induction Means
A Clearance Mechanism
An Authorizing Vibrational Match
A Frequency of Vibration in the Lock and Key Apparatus
Authorizing Vibrational Frequency
From claim 19:
Providing support services to the customer
Securely prepared
Securely delivered
Providing maintenance services to the customer
Maintenance needs
Providing security liaison services to the customer
Duties performed by security agents;
A diagnostic evaluation
A private communications network
Means for enabling secure exchanges of communications data
